(19) United States
(12) Patent Application Publication
(10) Pub. No.: US 2011/0305023 A1
(43) Pub. Date: Dec. 15, 2011

(54) DEVICE FOR HOMOGENIZING LASER RADIATION

(75) Inventors: Daniel Bartoschewski, Gelsenkirchen (DE); Manfred Jarczynski, Recklinghausen (DE)

(73) Assignee: LIMO PATENTVERWALTUNG GMBH & CO. KG, Gerstengrund (DE)

(21) Appl. No.: 13/203,510

(22) PCT Filed: Feb. 23, 2010
(86) PCT No.: PCT/EP10/01114

§ 371 Date: Aug. 26, 2011

(30) Foreign Application Priority Data
Feb. 26, 2009 (DE) 10 2009 010 693.6

(51) Int. Cl. G02B 27/12; F21V 5/04

(52) U.S. Cl. 362/259; 359/619; 359/625

(57) ABSTRACT

A device for homogenizing laser radiation has at least in a first direction perpendicular to a direction of propagation of the laser radiation partial beams spaced apart from each other, in particular for homogenizing laser radiation emanating from a laser diode bar, an array of refractive surfaces, which can deflect at least a majority of the partial beams of the laser radiation to be homogenized in such different manners that the beams run at least partially more convergingly to each other after passing through the refractive surfaces than before passing through the refractive surfaces. The device further has a lens device through which the partial beams, which have passed the array of refractive surfaces, can pass, wherein the lens device can superimpose at least some of the partial beams in a working plane.

The present invention relates to a device for homogenizing laser radiation which has partial beams mutually spaced apart at least in a first direction perpendicular to the propagation direction of the laser radiation, in particular for homogenizing laser radiation that emanates from a laser diode bar. Furthermore, the present invention relates to a laser device comprising a laser radiation source, in particular a laser diode bar, that can emit laser radiation that has partial beams mutually spaced apart in the direction perpendicular to the propagation direction of the laser radiation, and, furthermore, comprising a device for homogenizing laser radiation.

Definitions: in the propagation direction of the laser radiation means the mean propagation direction of the laser radiation, in particular when the latter is not a plane wave or is at least partially convergent or divergent. If not expressly otherwise specified, light beam, partial beam or beam is not meant as an idealized beam of geometric optics, but a real light beam such as, for example, a laser beam with a Gaussian profile that does not have an infinitesimally small beam cross section but, rather, an extended one.

Laser diode bars have a Gaussian near-field and far-field distribution in the fast axis. In the slow axis, there is a super-Gaussian near-field distribution, as a rule. Near-field and far-field distributions are transformed into one another by the collimation, for example, with the aid of a fast-axis collimating lens and/or a slow-axis collimating lens. There are various concepts for the generation of homogeneous lines or fields. Use can be made for this purpose of diffractive homogenizers, single-stage and two-stage refractive homogenizers and homogenizers based on Powell lenses (see, in this regard, by way of example F. M. Dickey, S. C. Holswade, “Laser beam shaping”, Marcel Dekker Inc., New York, 2000).

As a rule, diffractive homogenizers exhibit efficiency losses from emission in undesired diffraction orders. In addition, their diffraction efficiency is limited by the number of stages in the case of a quantized conversion.

Refractive homogenizers have the disadvantage that, in the case of Gaussian irradiation, diffraction at the grating of the array leads to interference, and thus to impairment of the homogeneity in the field. Since these array elements are illuminated coherently, and it is impossible to work out the lens transitions ideally, the result is efficiency losses and a reduction in homogeneity (by way of example, see WO 03/016963 A1 in this regard).

Powell lenses are based on a phase-shifting method and are sensible only with Gaussian sources.

The problem on which the present invention is based is to provide a device of the type mentioned at the beginning with the aid of which the laser radiation emanating from a laser diode bar can be more effectively homogenized. Furthermore, the aim is to specify a laser device having such a device.

This is achieved according to the invention by a device having the features of claim 1 and by a laser device having the features of claim 14. The subclaims relate to preferred embodiments of the present invention.

It is provided in accordance with claim 1 that the device comprises an array of refractive surfaces that can deflect at least a plurality of the partial beams of the laser radiation to be homogenized, doing this differently in such a way that they run at least partially more convergently to one another after passing through the refractive surfaces than before passage through the refractive surfaces, and that the device further comprises lens means through which the partial beams that have passed through the array of refractive surfaces can pass, the lens means being able to superpose at least some of the partial beams in a working plane. The concept is based on a suitable superposition of collimated single Gaussian or super-Gaussian sources. The superposition is carried out by means of optical array elements which are arranged in the spatial domain, are assigned to each single emitter, and add a specific angular offset in a targeted fashion to the far field thereof. The specific angular offset is dimensioned so that the resulting angular distribution overlaps in such a way as to produce a homogeneous field with Gaussian edges. The concept can be implemented with the aid of a refractive prism array.

It should be pointed out at this juncture that an inventive device can also be used to superpose partial beams arranged next to one another in two directions perpendicular to one another and to the propagation direction, in such a way as to produce a homogeneous intensity distribution. The aim thereby is for the present invention to be able to homogenize not only the laser radiation described in the exemplary embodiments and having a substantially one-dimensional cross section such as, for example, the laser radiation of a laser diode bar, but also a laser radiation having a two-dimensional cross section such as, for example, that of a stack of laser diode bars.

Claim 14 provides that the laser device comprises an inventive device for homogenizing laser radiation and that the angles between the refractive surfaces of the array are designed in such a way that the angular difference of the deviation that is experienced by neighboring partial beams at neighboring refractive surfaces of the array corresponds to between 75% and 95% of the full half-value width of the far-field distribution of one of the partial beams before passage through the device. Angular differences of this magnitude result in a comparatively homogeneous plateau of the far-field intensity distribution of the laser radiation homogenized by the inventive device.

In particular, it is possible in this case to design the angles between the refractive surfaces of the array, and/or the lens means in such a way that the angular differences of neighboring partial beams are respectively equal. Given partial beams of the same intensity distribution, this leads to good homogeneity of the superposed intensity distribution in the working plane. If the partial beams exhibit intensity distributions different from one another, for example a different super-Gaussian factor, it can be sensible to select different angular differences of neighboring partial beams.

Further features and advantages of the present invention emerge from the following description of preferred exemplary embodiments with reference to the attached figures, in which:

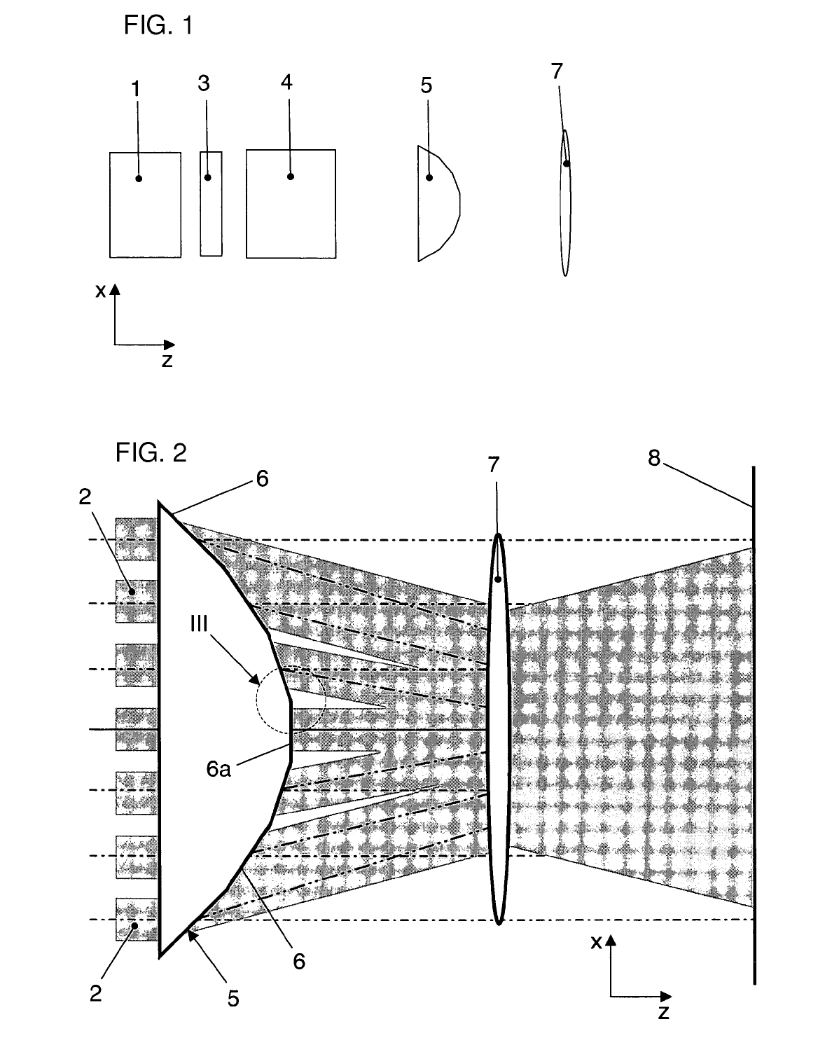

FIG. 1 is a schematic of an inventive laser device;

FIG. 2 is a schematic side view of an inventive device with exemplary beam paths;

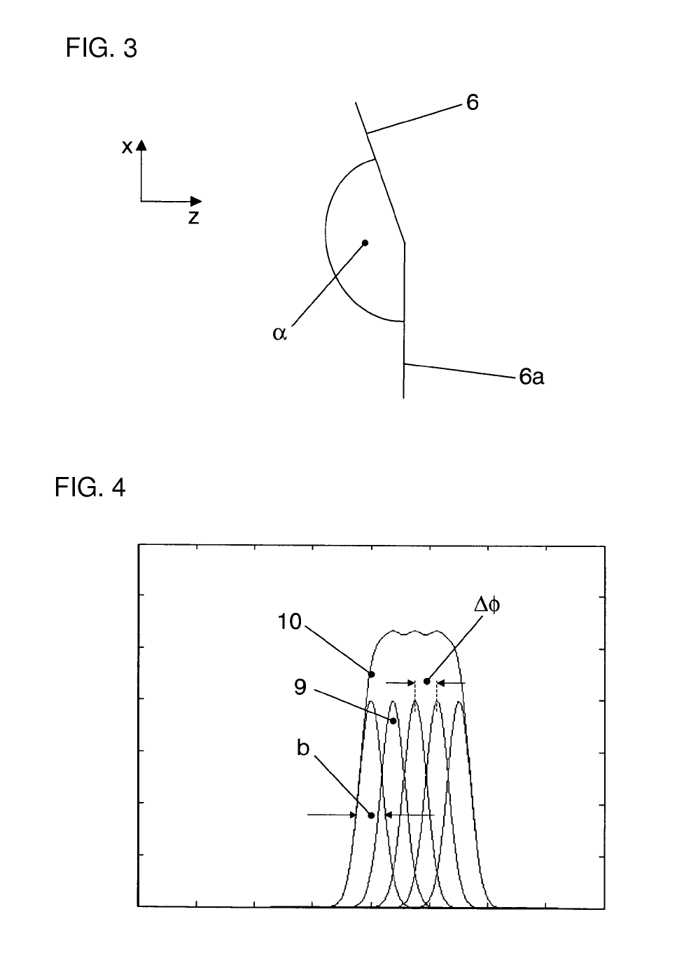

FIG. 3 is a detailed schematic in accordance with arrow III in FIG. 2;

FIG. 4 is a schematic of a superposition of a plurality of partial beams;

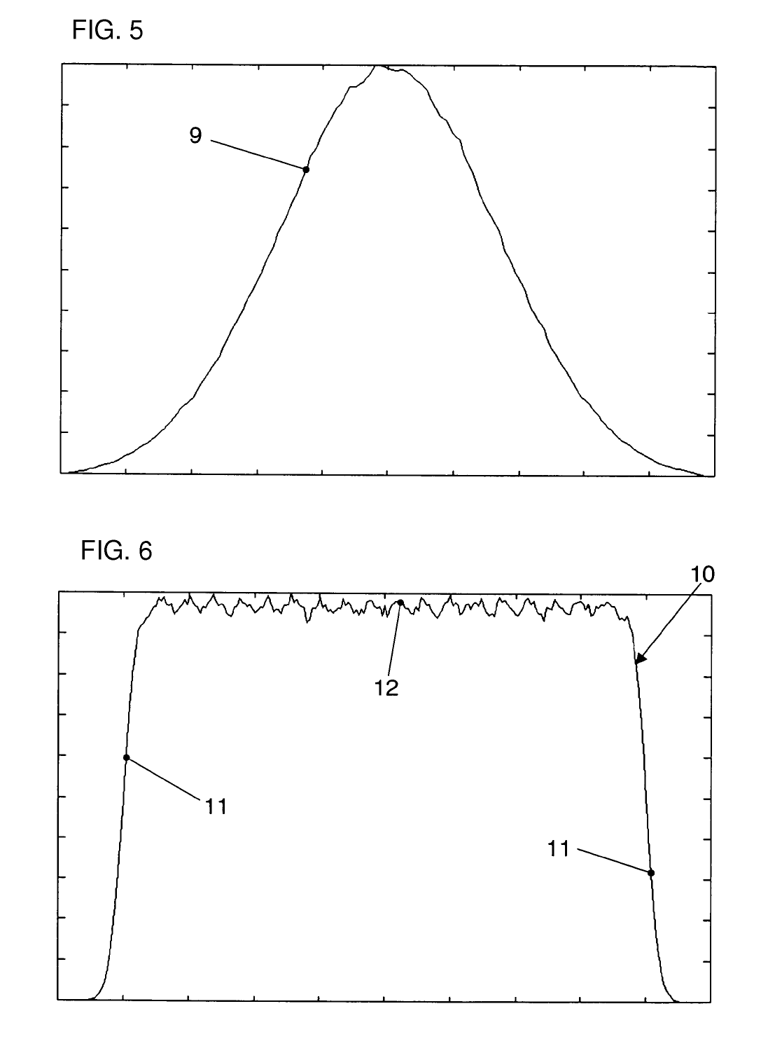

FIG. 5 shows a far-field intensity distribution of a single partial beam of the laser radiation; and

FIG. 6 shows a far-field intensity distribution of the laser radiation, homogenized with the aid of the inventive device.

Cartesian coordinate systems are drawn in for better orientation in some of the figures. Furthermore, identical or functionally identical parts or elements are provided with the same reference symbols in the figures.

Denoted by the reference symbol 1 in FIG. 1 is a laser diode bar that has individual emitters (not illustrated) arranged next to one another and mutually spaced apart in the so-called slow axis or in the X-direction in the figures.

By way of example, each of the emitters has a length of approximately 150 μm in the slow axis, the mutual spacing of two neighboring emitters in this direction being 400 μm or 500 μm, as a rule. The individual emitters emit partial beams 2 (see FIG. 2) of the laser radiation of the laser diode bar 1.

Indicated schematically in FIG. 1 downstream of the laser diode bar 1 in the propagation direction Z are fast-axis collimating means 3 that can collimate the individual partial beams 2 in the fast axis or in the Y-direction in the figures, and slow-axis collimating means 4 that can collimate the individual partial beams 2 in the slow axis or in the X-direction in the figures.

The fast-axis collimating means 3 can, for example, comprise a cylindrical lens whose cylinder axis extends in the X-direction. Furthermore, the slow-axis collimating means 4 can comprise, for example, a cylindrical lens whose cylinder axis extends in the Y-direction.

As an alternative to this, it is possible to provide in the propagation direction Z between the fast-axis collimating means 3 and the slow-axis collimating means 4 a beam transformation device that can rotate each of the individual partial beams 2 by 90° with regard to the propagation direction Z. This interchanges the divergence of the partial beams in the fast axis with that in the slow axis such that after passing through the beam transformation device the partial beams 2 are collimated in the slow axis or in the X-direction in the figures. Such beam transformation devices are adequately known and exhibit, by way of example, cylindrical lenses that are arranged next to one another in the X-direction and whose cylinder axes are aligned in the X-Y plane at an angle of 45° to the Y-direction.

Given the provision of such a beam transformation device, it would then be possible for the slow-axis collimating means 4 to comprise, for example, a cylindrical lens whose cylinder axis likewise extends in the X-direction.

In the propagation direction Z downstream of the fast- and slow-axis collimating means 3, 4, the inventive device comprises an array 5 having a flat entrance surface and a plurality of refractive surfaces 6 on the exit surface (see FIG. 2 in this regard). The array 5 is designed as a prism array, it being continued into the plane of the drawing of FIG. 2 or in the Y-direction, without changing its contour.

The refractive surfaces 6 are respectively flat and border one another in the X-direction. The refractive surfaces 6 respectively enclose an angle a with one another (see FIG. 3). The angle a between the surfaces 6 can respectively be between 150° and 180°, in particular between 165° and 180°, preferably between 175° and 179°.

In this case, the refractive surfaces 6 are dimensioned and arranged in such a way that respectively always one of the partial beams 2 strikes one of the refractive surfaces 6. The refractive surfaces 6 deflect the partial beams 2 in such a way that they run convergently to one another after exiting from the refractive surfaces 6. In particular, given an odd number of partial beams 2 a mean refractive surface 6a is provided that is arranged perpendicularly to the propagation direction Z of the laser radiation or in an X-Y plane. A partial beam 2 passing through the mean refractive surface 6a in the Z-direction is not deflected.

Provided downstream of the array 5 in the propagation direction Z of the laser radiation are lens means 7 that are, for example, designed as a biconvex lens in the exemplary embodiment illustrated. The lens means 7 can also be designed as a planar-convex or concave-convex lens. There is also the possibility, furthermore, of designing the lens means 7 as a cylindrical lens, in particular as a cylindrical lens with an aspheric contour.

The lens means 7 can superpose on one another in a working plane 8 the partial beams 2 that have exited from the array 5. In this case, the working plane 8 is arranged in the output-side focal plane of the lens means 7. The lens means 7 therefore serve as a Fourier lens, and can transform the angular distribution of the laser radiation into a spatial distribution in the working plane 8.

FIG. 5 shows a far-field intensity distribution 9 of a single partial beam 2 of the laser radiation. Said distribution essentially exhibits a Gaussian profile. FIG. 6 shows a far-field intensity distribution 10 of the laser radiation homogenized with the aid of the inventive device, in the case of which a plurality of, for example, 18, partial beams 2 are superposed in the far field. It is to be seen that the far-field intensity distribution 10 exhibits a comparatively homogeneous plateau 11 and Gaussian edges 12.

FIG. 4 illustrates the superposition of the far-field intensity distribution 9 of individual partial beams 2 to form a far-field intensity distribution 10. Here, the intensity of the far field is plotted in FIG. 4 against an angular coordinate. In the example illustrated in FIG. 4, five far-field intensity distributions 9 of individual partial beams 2 are superposed to form a common far-field intensity distribution 10.

It is to be seen that the individual partial beams 2 leave the array 5 at different angles. The angular difference A of neighboring partial beams with respect to each other corresponds to approximately 85% of the full half-value width b of the far-field distribution 9 of each of the individual partial beams 2.

Depending on whether the partial beams 2 exhibit a pure Gaussian profile or a modified Gaussian profile such as, for example, a super-Gaussian profile, a suitable angular difference Δφ of the deviation that neighboring partial beams 2 experience at neighboring refractive surfaces 6 of the array 5 should correspond to between 75% and 95% of the full half-value width b of the far-field distribution 9 of the partial beams 2 before passage through the device. Given angular differences in this range, the result is a comparatively homogeneous plateau 11 of the far-field intensity distribution 10 of the laser radiation homogenized with the aid of the inventive device.

Instead of an array 5, it is possible to provide two arrays, designed as prism arrays, arranged one behind another in the propagation direction Z of the laser radiation. In this case, the interspaces between individual partial beams 2 can be reduced in accordance with DE 10 2007 952 782.

1-15. (canceled)

16. A device for homogenizing laser radiation having partial beams mutually spaced apart at least in a first direction perpendicular to a propagation direction of the laser radiation, the device comprising
an array of refractive surfaces for deflecting at least a plurality of the partial beams of the laser radiation to be homogenized, said refractive surfaces deflecting the partials beams differently such that the partial beams run at least partially more convergently to one another after passing through said refractive surfaces than before passage through said refractive surfaces; and
a lens device through which the partial beams that have passed through said array of refractive surfaces can pass, said lens device being able to superpose at least some of the partial beams in a working plane.

17. The device according to claim 16, wherein each of the partial beams is respectively assigned one of said refractive surfaces of said array.

18. The device according to claim 16, wherein said refractive surfaces of said array are inclined to one another.

19. The device according to claim 16, wherein said refractive surfaces of said array are at least partially flat.

20. The device according to claim 16, wherein said refractive surfaces of said array are at least partially conjoined in the first direction.

21. The device according to claim 16, wherein said refractive surfaces of said array enclose at least partially with one another an angle between 150° and 180°.

22. The device according to claim 16, wherein said refractive surfaces of said array are disposed on a cylindrical contour.

23. The device according to claim 22, wherein a cylinder axis of said cylindrical contour extends in a second direction that is perpendicular to the first direction and to the propagation direction of the laser radiation to be homogenized.

24. The device according to claim 22, wherein said cylindrical contour is of convex shape.

25. The device according to claim 16, wherein said lens device has a converging lens.

26. The device according to claim 16, wherein said lens device defines an output-side focal plane and the working plane is disposed in the output-side focal plane.

27. The device according to claim 16, further comprising at least one collimating device for at least partially collimating the laser radiation to be homogenized with regard to at least one of the first direction or with regard to a second direction that is perpendicular to the first direction and to the propagation direction of the laser radiation to be homogenized.

28. The device according to claim 27, wherein said collimating device is disposed upstream of said refractive surfaces of said array in the propagation direction of the laser radiation to be homogenized.

29. The device according to claim 19, wherein said array is a prism array.

30. The device according to claim 16, wherein said refractive surfaces of said array enclose at least partially with one another an angle between 165° and 180°.

31. The device according to claim 16, wherein said refractive surfaces of said array enclose at least partially with one another an angle between 175° and 179°.

32. The device according to claim 16, wherein said lens device is composed of a converging lens.

33. The device according to claim 16, wherein the device homogenizes laser radiation emanating from a laser diode bar.

34. A laser device, comprising:
a laser radiation source emitting laser radiation that has partial beams mutually spaced apart in a direction perpendicular to a propagation direction of the laser radiation; and
a device for homogenizing the laser radiation, said device containing:
an array of refractive surfaces for deflecting at least a plurality of the partial beams of the laser radiation to be homogenized, said refractive surfaces deflecting the partial beams differently such that the partial beams run at least partially more convergently to one another after passing through said refractive surfaces than before passage through said refractive surfaces;
a lens apparatus through which the partial beams that have passed through said array of refractive surfaces can pass, said lens apparatus being able to superpose at least some of the partial beams in a working plane;
angles between said refractive surfaces of said array configured in such a way that an angular difference of a deviation that is experienced by neighboring partial beams at neighboring said refractive surfaces of said array correspond to between 75% and 95% of a full half-value width of a far-field distribution of one of the partial beams before passage through the laser device.

35. The laser device according to claim 34, wherein the angles between said refractive surfaces of said array, and/or said lens apparatus are configured in such a way that angular differences of neighboring partial beams are respectively equal.

36. The laser device according to claim 34, wherein said a laser radiation source is a laser diode bar.
